(19) United States
(12) Patent Application Publication
(10) Pub. No.: US 2013/0229128 A1
(43) Pub. Date: Sep. 5, 2013

(54) Circuit arrangement and method for operation of a high-pressure discharge lamp below its nominal power

(71) Applicants: Joachim Muehlschlegel, Groebenzell (DE); Andreas Kloss, Neubiberg (DE)

(72) Inventors: Joachim Muehlschlegel, Groebenzell (DE); Andreas Kloss, Neubiberg (DE)

(73) Assignee: OSRAM AG, Muenchen (DE)

(21) Appl. No.: 13/810,892

(22) PCT Filed: Oct. 24, 2011
(86) PCT No.: PCT/EP2011/068509

§ 371 Date: Jan. 18, 2013

(30) Foreign Application Priority Data
Nov. 9, 2010 (DE) 102010043604.6

(51) Int. Cl. H05B 41/38

(52) U.S. Cl. CPC H05B 41/38
USPC 315/268

(57) ABSTRACT

In various embodiments, a method for operating a high-pressure discharge lamp below its nominal power is provided, wherein the high-pressure discharge lamp is operated at nominal power with an alternating current having a predetermined operating frequency, and the lamp voltage is measured during a half-cycle at least at the start of a half-cycle and at the end of a half-cycle. The method may include: reducing the present operating frequency below an upper limit; and changing the current shape of the alternating current to a monopitch roof-shaped current shape, which is dependent on the difference in the lamp voltages at the end and at the start of the half-cycle.

### TECHNICAL FIELD

The invention relates to a method for operating a high-pressure discharge lamp below its nominal power with an AC voltage and an alternating current having a predetermined operating frequency.

### BACKGROUND

The invention is based on a method for operating a high-pressure discharge lamp below its nominal power with an alternating current having a predetermined operating frequency in accordance with the generic type of the main claim.

If the intention is for high-pressure discharge lamps, also referred to below as lamp, to be operated with dimming, various problems occur. Virtually all high-pressure discharge lamps available on the market are optimized in terms of their nominal power, with the result that the plasma-physical processes and the thermal balance of the lamp at the nominal lamp power proceed optimally and have the highest efficiency. In the text which follows, the nominal power of the high-pressure discharge lamp is regarded as being the power specified by the manufacturer for this lamp. Owing to the optimized plasma-physical processes and the likewise optimized thermal balance of the high-pressure discharge lamp, the high-pressure discharge lamp has good operational stability during operation at its nominal lamp power or rated power. During dimming of high-pressure discharge lamps, the operational stability sometimes suffers considerably since the thermal balance of the burner needs to operate ever further from its optimum as the dimming level increases. A large proportion of high-pressure discharge lamps available on the market is operated with alternating current. In this case, a rectangular operating current with a low frequency is usually used, which is also referred to as “wobbling DC operation”. In this case, a substantially rectangular current with a frequency of conventionally 50 Hz up to a few kHz is applied to the lamp. With each reversal between positive and negative voltage, the lamp commutates since the current direction is also reversed and therefore the current is temporarily brought to zero. This operation ensures that the electrodes of the lamp are subjected to a uniform load despite quasi DC operation.

The attachment of the arc to the electrodes is problematic in principle during operation of a gas discharge lamp with alternating current. During operation with the alternating current, a cathode becomes the anode and, conversely, an anode becomes the cathode during commutation of the operating voltage. The transition from cathode to anode is in principle unproblematic since the temperature of the electrode does not have any influence on the anode operation thereof. In the case of the transition from anode to cathode the capacity of the electrode to produce a sufficiently high current is dependent on the temperature of said electrode. If this temperature is too low, the arc changes during the commutation, usually after the zero crossing, from a temporary diffuse arc attachment operating mode (so-called “diffuse mode”) to a spot arc attachment operating mode (so-called “spot mode”). This change is sometimes associated with an often visible dip in the light emission, which can be perceived as flicker.

During dimming operation, the electrodes of the high-pressure discharge lamp become increasingly cold and, during commutation of the operating current, the lamp can begin to flicker and become unstable. These instabilities during commutation sometimes cause considerable electromagnetic interference.

### PROBLEM

The problem of the invention consists in specifying a method for operating a high-pressure discharge lamp below its nominal power with an alternating current having an predetermined operating frequency, which method causes less electromagnetic interference.

### DESCRIPTION OF THE INVENTION

The solution to this problem in respect of the method is provided according to the invention by a method for operating a high-pressure discharge lamp below its nominal power, wherein the high-pressure discharge lamp is operated at nominal power with an alternating current having a predetermined operating frequency, and the lamp voltage is measured during a half-cycle at least at the start of a half-cycle and at the end of a half-cycle, having the following steps:

reducing the present operating frequency below an upper limit,

changing the current shape of the alternating current to a monopitch roof-shaped current shape, which is dependent on the difference in the lamp voltages at the end and at the start of the half-cycle, in which the absolute value of the current |Iₛₜₐᵣₜ| at the beginning of the half-cycles with respect to the absolute value of the current |I_{end}| at the end of the half-cycles is, for example, |Iₛₜₐᵣₜ|:|I_{end}|=1:1.2 . . . 1:3.0. Owing to the monopitch roof-shaped current shape, the gas discharge lamp burner is heated until commutation to such an extent that commutation can be performed without any problems and without the above-described electromagnetic interference owing to a high-frequency current oscillation shortly after commutation.

Preferably, the absolute value of the current |Iₛₜₐᵣₜ| at the beginning of the half-cycles with respect to the absolute value of the current |I_{end}| at the end of the half-cycles is, for example, |Iₛₜₐᵣₜ|:|I_{end}|=1:1.5 . . . 1:3.0. These values ensure clean commutation even in the case of difficult lamps.

In a first configuration of the method, the upper limit is 120 Hz. Conventional lamps can thus be safely dimmed.

In a second configuration of the method, the upper limit is 80 Hz. Commercially available lamps which are classified as difficult can thus be dimmed safely.

In a third configuration of the method, the upper limit is 1 Hz. With this variant, special lamps which are very difficult to dim can also be dimmed readily.

The predetermined operating frequency is in this case generally 160 Hz.

In a preferred embodiment, the absolute value of the current |I_{end}| of the monopitch roof-shaped current shape according to the invention at the end of the half-cycles is increased when a threshold value for the difference in the lamp voltages at the end and at the start of the half-cycles is not reached.

Particularly preferably, the threshold value for the difference between the lamp voltages is split into a lower threshold value and an upper threshold value, and the absolute value of the current |I_{end}| at the end of the half-cycles is increased when the lower threshold value is undershot, and the absolute value of the current |I_{end}| at the end of the half-cycles is reduced when the upper threshold value is overshot.

In a further embodiment, the threshold value for the difference between the lamp voltages is split into a lower threshold value and an upper threshold value, and the absolute value of the current |Iₛₜₐᵣₜ| at the start of the half-cycles is increased when the lower threshold value is undershot, and the absolute value of the current |Iₛₜₐᵣₜ| at the start of the half-cycles is reduced when the upper threshold value is overshot.

In a further embodiment, in the event that the lower threshold value is undershot, the absolute value of the current |Iₛₜₐᵣₜ| at the start of the half-cycles and the absolute values of the current |I_{end}| at the end of the half-cycles is increased and, in the event of the upper threshold value being overshot, the absolute value of the current |Iₛₜₐᵣₜ| at the start of the half-cycles and the absolute value of the current |I_{end}| at the end of the half-cycles is reduced.

In this case, the threshold value for the difference between the lamp voltages is preferably between 0.2 volt and 3 volts. Furthermore, the upper threshold value is at most 0.5 volt greater than the lower threshold value.

The current shape of the alternating current at nominal power is preferably rectangular.

In the case of lamps with an unfavorable ratio of electrode diameter to nominal power, the current shape of the alternating current at nominal power is preferably monopitch roof-shaped, wherein the absolute value of the current |Iₛₜₐᵣₜ| at the beginning of the half-cycles with respect to the absolute value of the current |I_{end}| at the end of the half-cycles is, for example, |Iₛₜₐᵣₜ|:|I_{end}|=1:1 . . . 1:1.2.

The solution to the problem in respect of the circuit arrangement is provided by a circuit arrangement for operating a high-pressure discharge lamp below its nominal power, wherein the high-pressure discharge lamp is operated at nominal power with an alternating current having a predetermined operating frequency, and in this case the circuit arrangement implements the above-described method.

In this case, the circuit arrangement can have a design which is known per se. The circuit arrangement can contain a power factor correction circuit, which feeds an intermediate voltage circuit at its output, to which intermediate voltage circuit an inverter in the form of a full or half bridge is connected. The circuit arrangement can contain a pulse-operated or resonant starter in order to be able to start the high-pressure discharge lamp. The circuit arrangement can contain an analog or digital control circuit, which controls the power factor correction circuit and the inverter. Preferably, the circuit arrangement has a digital control circuit with a microcontroller.

Further advantageous developments and configurations of the circuit arrangement according to the invention and of the method according to the invention for operating a high-pressure discharge lamp below its nominal power result from further dependent claims and from the description below.

### BRIEF DESCRIPTION OF THE DRAWINGS

Further advantages, features and details of the invention result from the description below relating to exemplary embodiments and from the drawings, in which identical or functionally identical elements have been provided with identical reference symbols and in which:

FIG. 1 shows a lamp voltage profile with a very weakly pronounced diffuse spot transition at nominal power (curve 10) and strongly pronounced diffuse spot transition during dimming operation (53% of the nominal power, curve 12),

FIG. 2 shows a lamp current profile in the case of very weakly pronounced diffuse spot transition at nominal power (curve 20) and strongly pronounced diffuse spot transition during dimming operation (53% of the nominal power, curve 22),

FIG. 3 shows a plurality of lamp current profiles at 50 Hz, with curve 30 showing a lamp current profile at 100% of the nominal power, curve 32 showing a lamp current profile at 55% of the nominal power using an operating method according to the prior art, curve 34 showing a lamp current profile at 55% of the nominal power using the method according to the invention,

FIG. 4 shows a detail of the commutation of the lamp current profiles at 50 Hz shown in FIG. 3 with increased time resolution, with curve 40 showing the lamp current profile at 100% of the nominal power, curve 42 showing the lamp current profile at 55% of the nominal power using an operating method according to the prior art, and curve 44 showing the lamp current profile at 55% of the nominal power using the method according to the invention.

### PREFERRED EMBODIMENT OF THE INVENTION

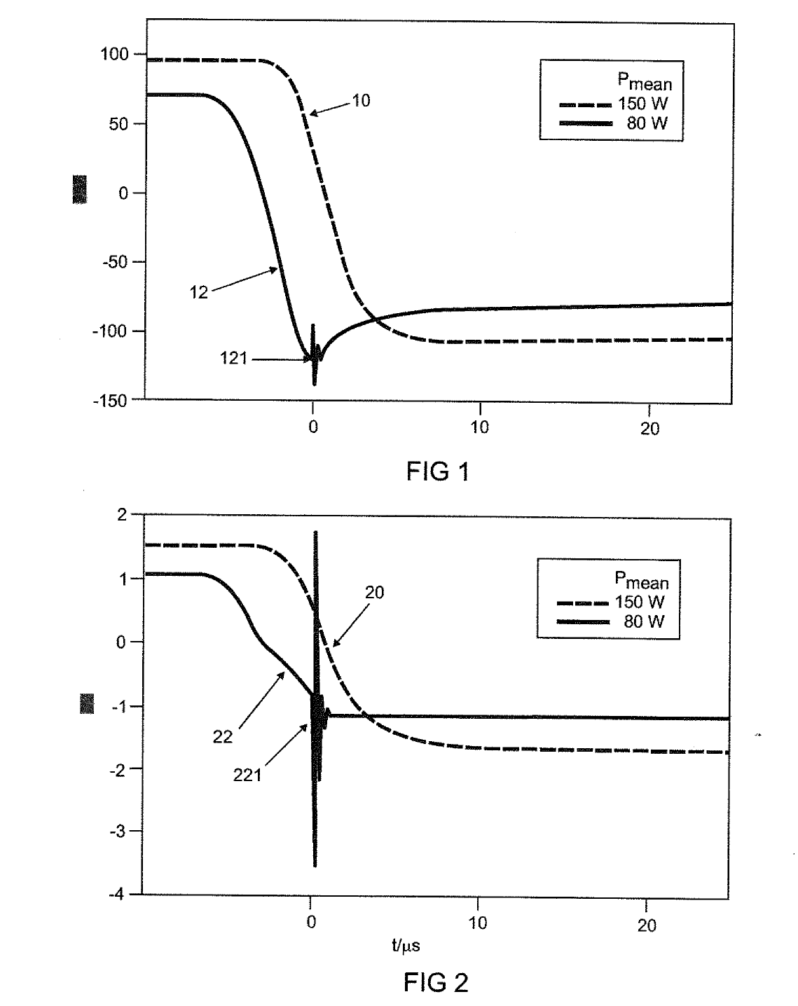

FIG. 1 shows a lamp voltage profile with a very weakly pronounced diffuse spot transition at nominal power (curve 10) and strongly pronounced diffuse spot transition 122 during dimming operation (53% of the nominal power, curve 12) given a time resolution of 10 μs/Div.

FIG. 2 shows the lamp current profile of the signals in FIG. 1 given very weakly pronounced diffuse spot transition at nominal power (curve 20) and strongly pronounced diffuse spot transition 221 during dimming operation (53% of the nominal power, curve 22) given a time resolution of 10 μs/Div. These two figures clarify the problem on which the invention is based. During dimming operation, the electrodes become too cold, and with each commutation problems arise during transition from the diffuse arc attachment operating mode to the spot arc attachment operating mode, precisely the diffuse-spot transition 121 or 221 already mentioned above. This can clearly be seen in curves 12 and 22, respectively, where at this transition a sharp upswing arises at the diffuse-spot transition 121, 221, which is reflected as high-frequency interference in the spectrum. In order to be able to maintain the limit values for electromagnetic compatibility with such an operating mode, large and expensive filter components are required. In addition, these instabilities are noticeable as flicker during operation in the case of commutation. Therefore, a monopitch roof-shaped lamp current according to the invention is proposed for dimmed operation which has an absolute value |Iₛₜₐᵣₜ| at the beginning of the half-cycles with respect to the absolute value |I_{end}| at the end of the half-cycles of |Iₛₜₐᵣₜ|:|I_{end}|=1:1.2 to 1:3.0. Particularly preferably, the mean value for the lamp current at the end of the half-cycle is twice as great as at the beginning of the half-cycle. According to the invention, the lamp current is variable during the half-cycles and is dependent on the change in the lamp voltage during a half-cycle. The level of the lamp current rise during a half-cycle, i.e. the ratio of the start current to the end current |Iₛₜₐᵣₜ|:|I_{end}|, is dependent on the lamp voltage and primarily on the change in lamp voltage which is present during the half-cycle. The change in the lamp current in a half-cycle is adjusted in such a way that the lamp voltage has risen by a previously calculated or a predetermined value ΔU₁, ΔU₂. The threshold value for voltage rise in the lamp voltage in the half-cycle is between 0.2V and 4V, depending on the gas discharge lamp. The threshold value is preferably split into a lower threshold value and an upper threshold value. The voltage rise is calculated from the difference between the lamp voltage at the end of the half-cycle and the lamp voltage at the beginning of the half-cycle. If the threshold value for the lamp voltage rise within the half-cycle is not reached, the ratio of the start current to the end current for the next half-cycle |Iₛₜₐᵣₜ|:|I_{end}| is increased in order to heat the cathode to a greater extent and, as far as possible, to avoid a pronounced diffuse-spot transition during commutation. In order to achieve a robust control characteristic, the ratio of the start current to the end current for next half-cycle |Iₛₜₐᵣₜ|:|I_{end}| is increased when a lower threshold value for the voltage rise in the lamp voltage in the half-cycle is undershot and is decreased when an upper threshold value for the voltage rise in the lamp voltage in the half-cycle is overshot. If the rise in the lamp voltage is in the range between the lower and the upper threshold value, the ratio of the start current to the end current for the next half-cycle |Iₛₜₐᵣₜ|:|I_{end}| will be maintained.

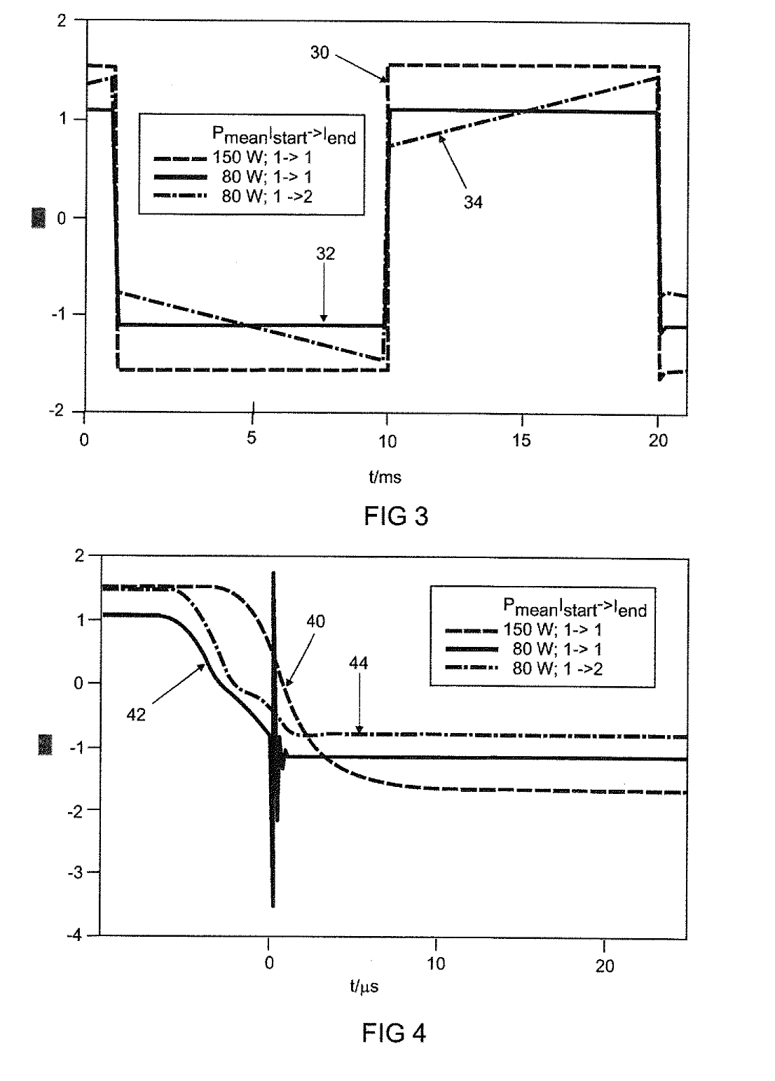

FIG. 3 shows the lamp current profiles at 50 Hz, with curve 30 showing the lamp current profile at 100% of the nominal power, curve 32 showing the lamp current profile at 55% of the nominal power using an operating method according to the prior art, and curve 34 showing the lamp current profile at 55% of the nominal power using the operating method according to the invention given a time resolution of 10 ms/Div. The monopitch roof-shaped current profile can be seen easily in curve 34; in this case the lamp current at the end of the half-cycle is twice as great as at the beginning of the half-cycle. However, this would be insufficient to ensure stable operation of the high-pressure discharge lamp at low dimming levels. Surprisingly, it has been demonstrated that safe operation of the high-pressure discharge lamp can be achieved by virtue of the monopitch roof-shaped current shape being combined with a very low-frequency operation. This can explained from the fact that the electrode which makes the transition from anode to cathode in the next commutation is always heated by the temporary quasi DC operation since the high operating temperature of the electrode is only required for the cathode operation of the electrode. The other electrode naturally cools down to a greater extent in this phase, but this in unproblematic for the next commutation since the electrode then undergoes a change from cathode to anode and the temperature is irrelevant for the anode operation of the electrode. After this commutation, however, said electrode is, in the anode operation mode, again heated for the same length of time in order then to have a sufficiently high temperature for the transition from anode to cathode. According to the invention, therefore, the operation frequency in the dimming operation is decreased below an upper limit in order to achieve this stable operation. The upper limit is at most 120 Hz; preferably the operation frequency is reduced to a frequency of around 50 Hz to 60 Hz. Lower frequencies can be problematic since the human eye demonstrates increased sensitivity to flicker at an operating frequency below 50 Hz, and this has a negative effect on the dimming operation. Only below one hertz does the flicker sensitivity of the human eye decrease again, with the result that very low operating frequencies are also possible. At very low dimming levels, surprisingly stable operation of the high-pressure discharge lamp can be achieved at very low operating frequencies below one hertz. The particularly preferred operating frequency according to the invention is therefore between 50 Hz and 60 Hz, and below 1 Hz at very low dimming levels. In this case, too, according to the invention the rise in the lamp voltage in a half-cycle is measured again and the ratio of start current to end current |Iₛₜₐᵣₜ|:|I_{end}| for the next half-cycle is matched correspondingly to the voltage rise in the present half-cycle.

FIG. 4 shows a detail of the commutation of the lamp current profiles at 50 Hz from FIG. 3 with a higher degree of time resolution, with curve 40 showing the lamp current profile at 100% of the nominal power, curve 42 showing the lamp current profile at 55% of the nominal power using an operating method according to the prior art, and curve 44 showing the lamp current profile at 55% of the nominal power using the method according to the invention. The time resolution is in this case no more than 10 ms/Div, but only 10 μs/Div. In particular, the commutation of the lamp current is illustrated. It can clearly be seen that, with the operating method according to the invention (curve 44), significantly less interference occurs than with an operating method according to the prior art (curve 42). Virtually no interference occurs during commutation of the lamp current any more with the operating method according to the invention, and a circuit arrangement which implements the operating method according to the invention can be subjected to interference suppression significantly more easily and can therefore be produced substantially less expensively.

1. A method for operating a high-pressure discharge lamp below its nominal power, wherein the high-pressure discharge lamp is operated at nominal power with an alternating current having a predetermined operating frequency, and the lamp voltage is measured during a half-cycle at least at the start of a half-cycle and at the end of a half-cycle, the method comprising:
reducing the present operating frequency below an upper limit; and
changing the current shape of the alternating current to a monopitch roof-shaped current shape, which is dependent on the difference in the lamp voltages at the end and at the start of the half-cycle.

2. The method as claimed in claim 1,
wherein the absolute value of the current |Iₛₜₐᵣₜ| at the beginning of the half-cycles with respect to the absolute value of the current |I_{end}| at the end of the half-cycles is |Iₛₜₐᵣₜ|:|I_{end}|=1:1.5 . . . 1:3.0.

3. The method as claimed in claim 1,
wherein the upper limit of the present operating frequency is 120 Hz.

4. The method as claimed in claim 1,
wherein the upper limit of the present operating frequency is 80 Hz.

5. The method as claimed in claim 1,
wherein the upper limit of the present operating frequency is 1 Hz.

6. The method as claimed in claim 1,
wherein the predetermined operating frequency is 160 Hz.

7. The method as claimed in claim 1,
further comprising increasing the absolute value of the current |I_{end}| at the end of the half-cycles when a threshold value for the difference between the lamp voltages at the end and at the start of the half-cycles is not reached.

8. The method as claimed in claim 1,
further comprising splitting the threshold value for the difference between the lamp voltages into a lower threshold value and an upper threshold value, and
increasing the absolute value of the current |I_{end}| at the end of the half-cycles when the lower threshold value is undershot, and the absolute value of the current |I_{end}| at the end of the half-cycles is reduced when the upper threshold value is overshot.

9. The method as claimed in claim 1,
further comprising splitting the threshold value for the difference between the lamp voltages into a lower threshold value and an upper threshold value, and
increasing the absolute value of the current |Iₛₜₐᵣₜ| at the start of the half-cycles when the lower threshold value is undershot, and the absolute value of the current |Iₛₜₐᵣₜ| at the start of the half-cycles is reduced when the upper threshold value is overshot.

10. The method as claimed in claim 8,
further comprising increasing the absolute value of the current |Iₛₜₐᵣₜ| at the start of the half-cycles and the absolute value of the current |I_{end}| at the end of the half-cycles in the event that the lower threshold value is undershot and, reducing the absolute value of the current |Iₛₜₐᵣₜ| at the start of the half-cycles and the absolute value of the current |I_{end}| at the end of the half-cycles in the event that the upper threshold is overshot.

11. The method as claimed in claim 1,
wherein the threshold value for the difference between the lamp voltages is between 0.2 volt and 3 volts.

12. The method as claimed in claim 11,
wherein the upper threshold value is at most 0.5 volt greater than the lower threshold value.

13. The method as claimed in claim 1,
wherein the current shape of the alternating current at nominal power is rectangular.

14. The method as claimed in claim 1,
wherein the current shape of the alternating current at nominal power is monopitch roof-shaped, wherein the absolute value of the current |Iₛₜₐᵣₜ| at the beginning of the half-cycles with respect to the absolute value of the current |I_{end}| at the end of the half-cycles is |Iₛₜₐᵣₜ|:|I_{end}|=1:1 . . . 1:1.2.

15. A circuit arrangement for operating a high-pressure discharge lamp below its nominal power, wherein the high-pressure discharge lamp is operated at nominal power with an alternating current having a predetermined operating frequency, and
wherein the high-pressure discharge lamp is operated at nominal power with an alternating current having a predetermined operating frequency, and the lamp voltage is measured during a half-cycle at least at the start of a half-cycle and at the end of a half-cycle, by
reducing the present operating frequency below an upper limit; and
changing the current shape of the alternating current to a monopitch roof-shaped current shape, which is dependent on the difference in the lamp voltages at the end and at the start of the half-cycle.

16. The method as claimed in claim 1,
wherein the absolute value of the current |Iₛₜₐᵣₜ| at the beginning of the half-cycles with respect to the absolute value of the current |I_{end}| at the end of the half-cycles is |Iₛₜₐᵣₜ|:|I_{end}|=1:1.2 . . . 1:3.0.

17. The method as claimed in claim 9,
further comprising increasing the absolute value of the current |Iₛₜₐᵣₜ| at the start of the half-cycles and the absolute value of the current |I_{end}| at the end of the half-cycles in the event that the lower threshold value is undershot and,
reducing the absolute value of the current |Iₛₜₐᵣₜ| at the start of the half-cycles and the absolute value of the current |I_{end}| at the end of the half-cycles in the event that the upper threshold is overshot.
